(19) United States
(12) Patent Application Publication
(10) Pub. No.: US 2006/0165354 A1
(43) Pub. Date: Jul. 27, 2006

(54) Digital video recording apparatus

(75) Inventor: Kwang Ho Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/305,296

(22) Filed: Dec. 19, 2005

(30) Foreign Application Priority Data
Jan. 26, 2005 (KR) 10-2005-0007299

(51) Int. Cl. H04N 5/91

(52) U.S. Cl. 385/95; 386/95

(57) ABSTRACT

A digital video recording apparatus and method is provided which can associate a text-based search function with a graphic-based search function and perform a searching operation according to a user's desired search function, thereby providing searching convenience to the user. The apparatus can display text-based and graphic-based search functions on a single screen such that the user can easily recognize a recording state of recording data, rapidly search recording data, and improve search functions. For this, the apparatus includes an input unit for inputting time information to be searched through a search screen, based on characters or selection of pictures, and a searching unit for searching recording data according to the input time information.

### CROSS-REFERENCE TO RELATED APPLICATION

This application claims the benefit under 35 U.S.C §119(a) of Korean Patent Application No. 10-2005-0007299, filed in the Korean Intellectual Property Office on Jan. 26, 2005, the entire disclosure of which is incorporated herein by reference.

### BACKGROUND OF THE INVENTION

1. Field of the Invention

The present invention relates to a digital video recording apparatus. More particularly, the present invention relates to a digital video recording apparatus that is capable of selectively and conveniently searching information related to recording data, and thus enhancing search performance thereof.

2. Description of the Related Art

Generally, a digital video recording (DVR) apparatus serves to convert image data received through a camera as viewed through a monitor, from analog signals into digital signals to generate digital data, compress and store the digital data in a hard disk drive (HDD) in computers such as a personal computer and so forth, and search for or reproduce images corresponding to the image data based on a selection of date, time, camera, and so forth.

Such a DVR apparatus, as a next generation monitoring apparatus, is replacing current monitoring systems comprised of a prior art CCD camera, VCR, tape, and so forth. The DVR apparatus is employed for various uses in factories, offices, banks, security companies, hospitals, apartment complex, hotels, kindergartens, and other locations. Unlike a monitoring system employing an analog technique, such as a conventional VCR, since the DVR apparatus converts analog data into digital data to store the data in an HDD, DVD-RAM or similar memory, the data can be semipermanently maintained.

The DVR apparatus has advantages in that data can be rapidly searched with a simple operation. Also, the DVR apparatus can simultaneously search a plurality of cameras, and instantly select a specific camera based on designation of dates, hours, and minutes. Namely, the DVR apparatus has improved search functions such that users can easily select and search specific information of recorded data, thereby reproducing the specific information.

As shown in FIG. 1, in order to use a conventional searching method function, a user must individually set a year, month, day, hour, minute, and second, as denoted by reference numeral 1, for recording data stored in a HDD, and then command a search start. Then, corresponding recording data is searched in the recording data based on the time. If there is no recording data at the set time, the search operation fails.

The DVR apparatus can support a graphic-based search function, as shown in FIGS. 2A to 2C, as well as a text-based search function. As shown in FIG. 2A, the graphic-based search function highlights or colors a date, denoted by reference numeral 2, when recording data is stored to inform a user that corresponding data is stored. If the user selects a desired date from among the dates for desired recording data using a cursor, each channel shows hours, denoted by reference numeral 3, when the recording data was recorded on the desired date, as shown in FIG. 2B. After that, if the user further selects a corresponding hour using a cursor, each channel shows minutes, denoted by reference numeral 4, when the recording data was recorded on the corresponding hour, as shown in FIG. 2C. After that, the user selects corresponding minutes to be searched for the desired recording data using a cursor. Similarly, the procedure can be continued for corresponding seconds to be searched. As a result, for each desired recording data, the user must repeatedly perform the above procedure for the desired recording data.

However, the conventional searching method has a disadvantage in that it is inconvenient for users. Also, when using a text-based search function, in order to search corresponding recording data in a DVR apparatus, the users must input and set texts, such as year, month, day, hour, minute, and second. Also, it has a drawback in that, since users do not know the result of whether corresponding data is recorded therein on a corresponding time input by the users until the searching operation is finished, the search operation frequently fails to produce desired results.

Also, the conventional searching method has a disadvantage in that a searching speed is slow such that it is relatively time consuming to search corresponding data. Namely, when using a graphic-based search function, users are required to change search screens three or four times to select minute or second conditions. Also, although the users know the desired data and time of the recording data, they must still pass the above described several stages to access the desired recording data.

Accordingly, a need exists for a system and method for selectively and conveniently searching information related to recording data to enhance search performance.

### SUMMARY OF THE INVENTION

Therefore, it is an object of the present invention to substantially solve the above and other problems, and provide a digital video recording apparatus that is capable of associating a text-based search function with a graphic-based search function, and performing a searching operation according to a user's desired search function, thereby providing searching convenience to the user.

It is another object of the present invention to provide a digital video recording apparatus that is capable of displaying text-based and graphic-based search functions on a single screen such that a user can easily recognize a recording state of recording data, rapidly search recording data, and improve search functions.

In accordance with an embodiment of the present invention, the above and other aspects can be substantially achieved by providing a digital video recording apparatus comprising an input unit for inputting time information to be searched through a search screen, based on characters or selection of pictures, and a searching unit for searching recording data according to the input time information.

Preferably, the search screen can display a text portion to input the time information based on characters, and a graphic portion to display a time when the recording data is recorded based on a picture.

Preferably, the search screen can also display the time information of originally recorded recording data of the recording data based on the text portion and the graphic portion when initiating a search of the recording data.

Preferably, the search screen can also display information of the time when the recording data was originally recorded, including an input date, on the text portion, and an hour displaying area of time when the recording data was recorded on an input date, on the graphic portion, if the input unit inputs the time information including up to the desired search date and the searching unit completes a searching operation based on the time information.

Preferably, the search screen can also display information of the time when the recording data was originally recorded, including an input hour, on the text portion, and a minute displaying area of time when the recording data was recorded on an input hour, on the graphic portion, if the input unit inputs the time information including up to the desired search hour and the searching unit completes a searching operation based on the time information.

### BRIEF DESCRIPTION OF THE DRAWINGS

These and other objects and advantages of the present invention will become apparent and more readily appreciated from the following description of the embodiments, taken in conjunction with the accompanying drawings, of which:

FIG. 1 is a view illustrating a text-based screen for searching recording data of a conventional DVR;

FIGS. 2A to 2C are views illustrating a graphic-based screen for searching recording data of a conventional DVR;

FIG. 3 is a block diagram illustrating a DVR apparatus according to an embodiment of the present invention;

FIGS. 4A to 4C are views illustrating a screen for searching recording data of the DVR apparatus of FIG. 3 according to an embodiment of the present invention; and

FIG. 5 is a flowchart illustrating a method for searching recording data of the DVR apparatus of FIG. 3 according to an embodiment of the present invention.

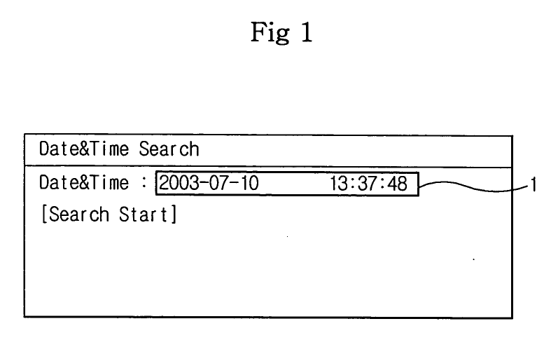

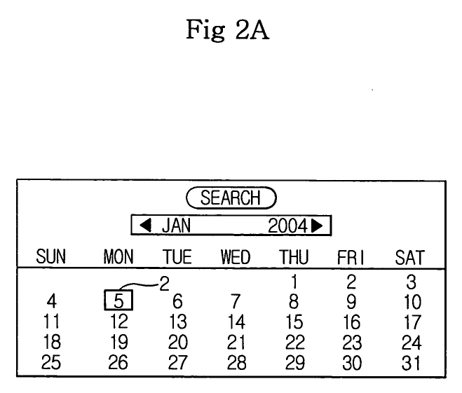

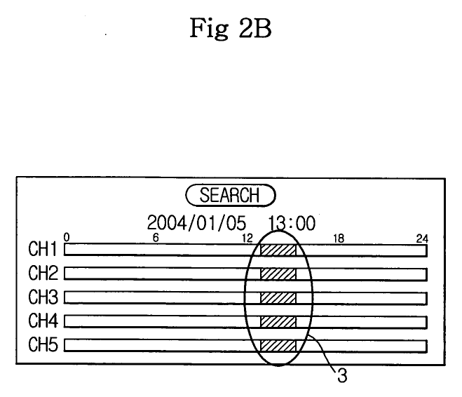

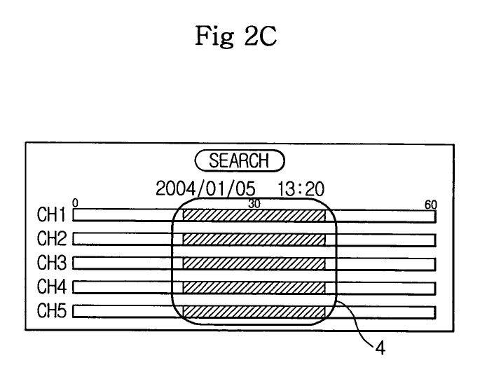

Throughout the drawings, like reference numerals will be understood to refer to like parts, components and structures.

### DETAILED DESCRIPTION OF THE EXEMPLARY EMBODIMENTS

Reference will now be made in detail to embodiments of the present invention, examples of which are illustrated in the accompanying drawings, wherein like reference numerals refer to like elements throughout. The embodiments are described below to explain the present invention by referring to the figures.

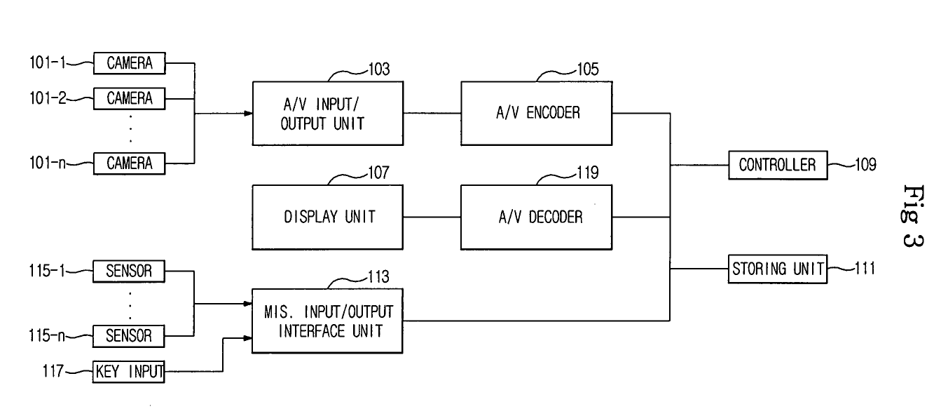

FIG. 3 is a block diagram illustrating a digital video recording (DVR) apparatus according to an embodiment of the present invention, in which the DVR apparatus comprises a plurality of cameras 101-1˜101-n, an audio/video (A/V) input/output unit 103, an A/V encoder 105, an A/V decoder 119, a display unit 107, a controller 109, a storing unit 111, a miscellaneous input/output interface unit 113, a plurality of sensors 115-1˜115-n, and a key input 117.

The A/V input/output unit 103 inputs audio and video signals from the plurality of cameras 101-1 to 101-n through external input leads, and converts the audio and video signals into digital signals to generate frame data.

The A/V encoder 105 inputs and encodes the frame data from the A/V input/output unit 103. Here, encoding denotes processes, such as creation of data in bit stream format using techniques such as MPEG. The A/V encoder 105 initiates an encoding operation when receiving an encoding start command from the controller 109 and terminates its encoding operation based on a stop command.

The storing unit 111 stores the video and audio recording data encoded in the A/V encoder 105. The storing unit 111 can be implemented using a hard disc drive (HDD), such as a personal computer or similar device.

The A/V decoder 119 decodes the video and audio recording data stored in the storing unit 111 when receiving a decoding start command from the controller 109. Here, decoding denotes processes, such as a retrieving operation to retrieve frame data from data in bit stream.

The display unit 107 performs analog/digital conversion for the frame data output from the A/V decoder 119, and outputs the converted video and audio signals through a monitor and a speaker (not shown).

The miscellaneous input/output interface unit 113 inputs corresponding key data from the key input 117, in which the key input 117 inputs various commands for controlling the DVR apparatus, and transmits the corresponding key data to the controller 109. The miscellaneous input/output interface unit 113 can also input sensing signals from the plurality of sensors 115-1 to 115-n, which are installed externally from the DVR apparatus, and transmit the sensing signals to the controller 109. When receiving the sensing signals from the plurality of sensors 115-1 to 115-n via the miscellaneous input/output interface unit 113, the controller 109 controls the storing unit 111 to store signals input from a corresponding camera therein. Namely, the input of detection signals from the plurality of sensors 115-1 to 115-n causes a recording operation start. The recording operation start can be performed by the input of a recording start command key data, an operation of a timer according to a recording schedule and so forth, as well as by the input of detection signals from the plurality of sensors 115-1 to 115-n.

As such, the controller 109 commands the start of an encoding operation of the A/V encoder 105 if the controller 109 inputs a report of movement detection from the A/V encoder 105, a report of sensing detection from the plurality of sensors 115-1 to 115-n, a command corresponding to a recording button through the key input 117, or a report indicative of a recording start time point from a timer according to a recording schedule. Based on the control of the controller 109, the A/V encoder 105 encodes A/V signals from corresponding cameras 101-1 to 101-n and stores the encoded signals in the storing unit 111. The termination time point of the recording operation performed by the recording start can be designated at a predetermined time according to the implementation of the DVR apparatus or set such that the recording operation is maintained until key data for a recording stop operation is entered.

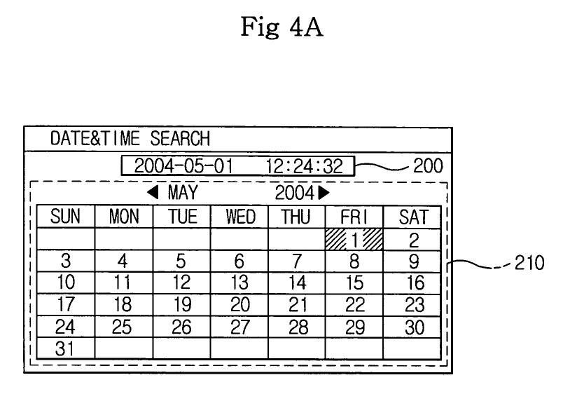

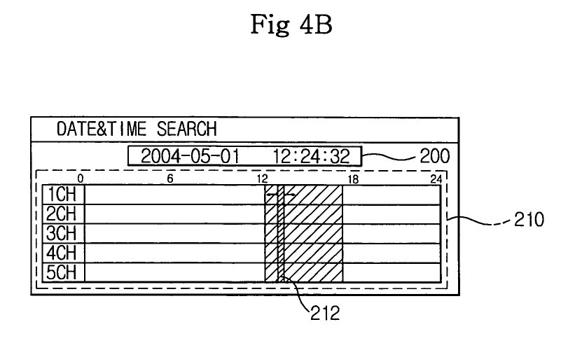

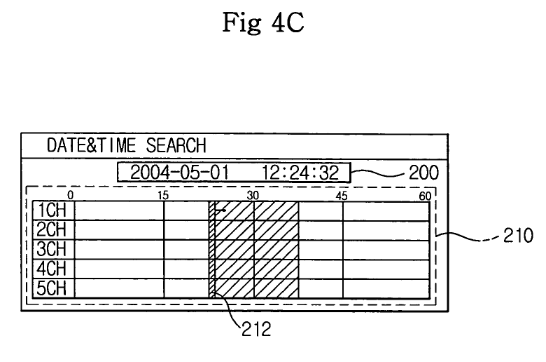

If a user operates the key input unit 117 to select a search function in order to search corresponding recording data in recording data stored in the storing unit 111, the display unit 107 displays a search screen thereon, as shown in FIG. 4A. FIG. 4A is an originally displayed screen comprised of a text portion 200 and a graphic portion 210, provided when selecting a search function. The position and size of portions 200 and 210 are presented as examples in FIGS. 4A to 4C, and are not limited thereto. The text portion 200 displays date and time of data originally recorded in the storing unit 111, and the graphic portion 210 displays a calendar of a corresponding month in which the displayed date is included, in which the calendar highlights or colors date(s) in order to indicate that data is recorded on the indicated date(s). More specifically, as shown in FIG. 4A, the text portion 200 displays an exemplary date of May 1, 2004, and an exemplary time of 12:24:32, indicating that data was initially recorded in the storing unit 111, and the graphic portion 210 displays an exemplary calendar of May, 2004 thereon. Also, the date of May 1, 2004, is colored to indicate that data was recorded on that date. The specific dates and times illustrated in FIG. 4A are for illustration purposes, and the present invention is not limited thereto.

FIG. 4B is a view illustrating a search screen when a searched date is input to the initial search screen of FIG. 4A through the text portion 200 or when a searching date is selected in the graphic portion 210 using a cursor. The text portion 200 then displays an initial recording time of data recorded on the searching date, and the graphic portion 210 then displays each channel recording time of data on the searching date. For example, when a signal is input for searching data recorded on May 1, 2004, the text portion 200 displays 12:24:32 as an initial time when data was recorded on May 1, 2004, together with the graphic portion 210 that displays time blocks in channels between 1200 hours (12 p.m.) to 1800 hours (6 p.m.) on May 1, 2004, indicating that data was recorded in the time blocks. If a user wishes to specifically search corresponding recording data, the user can directly input a corresponding minute and second value in the text portion 200 or set a searching position using a tool bar 212 in the graphic portion 210.

As such, when a search condition is set up to the desired search minute condition in the search function as shown in FIG. 4C, the text portion 200 then displays an initial recording hour of recording data recorded in the searching time thereon, and the graphic portion 210 then displays the minutes of recording data recorded in the searching time, based on each channel, thereon. For example, when recording data corresponding to 1200 hours (12 p.m.) on May 1, 2004 is searched, the text portion 200 displays minute and second, 24′:32″, in which data is recorded at 12 p.m. on May 1, 2004, and the graphic portion 210 displays states wherein data is recorded, from minute 20 of 12 p.m. to minute 40 on May 1, 2004. Here, the user can directly input searching time points to the text portion 200 or set searching positions by adjusting the toolbar 212 in the graphic portion 210.

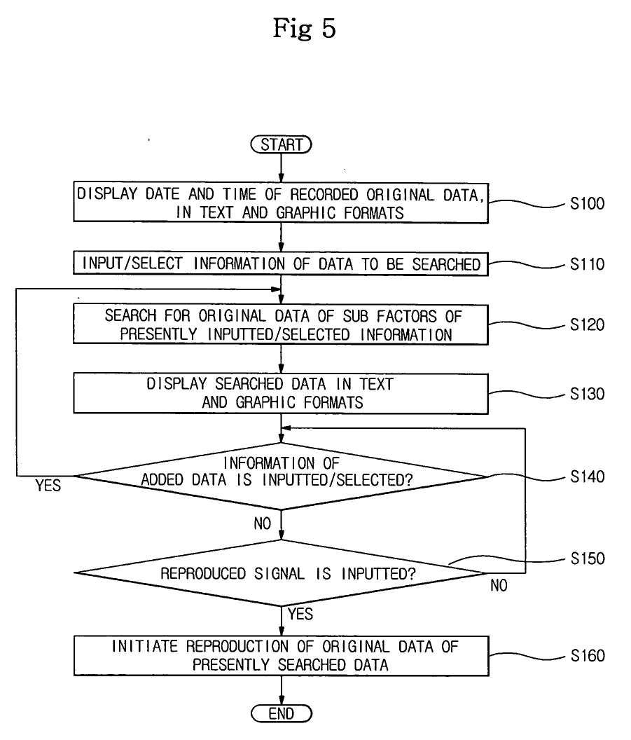

With reference to FIG. 5, a method for searching recording data of a DVR apparatus is described in detail. Firstly, when a search function is selected via the key input unit 117, the controller 109 controls the display unit 107 to display date and time of the initially recorded data of the recording data stored in the storing unit 111 on the text portion 200 and the graphic portion 210, as shown in FIG. 4A, in step S100.

When a search screen is displayed by the display unit 107, date and time for recording data to be searched can be directly input in the text portion 200 of the search screen, or a date corresponding to recording data of displayed dates in the graphic portion 210 can be selected by using a cursor, such that time information of the corresponding recording data is input/selected in step S110.

Next, sub items of information for the input/selected date or time are used for searching the initial data in step S120. For example, when the text portion 200 or the graphic portion 210 inputs a signal for searching for information corresponding to a date of May 1, 2004 in step S110, a time when data is initially recorded on the same date is searched.

When corresponding data is searched, they are displayed on the text portion 200 and the graphic portion 210 in step S130. For example, as shown in FIG. 4B, the text portion 200 displays the date May 1, 2004, in 2004-05-01 format, and displays the time 12 clock 24 minutes 32 seconds, in 12:24:32 format, which indicates a record that initial data was recorded. Also, the graphic portion 210 displays a time block from 1200 hours (12 p.m.) to 1800 hours (6 p.m.) on May 1, 2004, on each channel, in which the time block indicates that the initial data was recorded from 12 p.m. to 6 p.m. on the same date. If a signal for searching for information corresponding to date and time, that is, at 12 p.m. on May 1, 2004, is input in step S110, the display unit displays a screen thereon, as shown in FIG. 4C, in step S130.

Next, a determination is made as to whether time information of recording data to be additionally searched is input/selected in step S140. If additional information is input thereto, the procedure returns to step S120 to repeatedly perform the above processes. Here, the additional information denotes detailed information for searching time. The additional information is input after a signal for searching for information corresponding to a date of May 1, 2004 is input thereto in step S10.

If additional information is not input/selected, a determination is made as to whether a reproduction signal is input in step S150. When the reproduction signal is input, a reproduction operation of data searched for the input/selected date or time is performed from the initially recorded data in step S160.

As such, when recording data is searched, the search screen displays a text portion and a graphic portion together, such that a date to be searched can be directly input in the text portion to search corresponding data, and sequentially proceed while date, time, and minute, which are information that denote when data was recorded, are confirmed through the graphic portion. Also, the text portion and the graphic portion can be sequentially used rather than jointly. Even though time information to be searched is not set or selected up to the desired search minute condition, if the searching operation of embodiments of the present invention is performed, reproduction is performed from the initial recorded data according to the time information input/selected before setting the minute conditions.

As described above, the digital video recording apparatus according to embodiments of the present invention can search recording data stored therein simultaneously using the text portion and the graphic portion such that, if a user knows the correct time to be searched, the searching operation can be rapidly performed through the text portion, and if the user does not know a storing state of recording data, the searching operation can be proceed while the user confirms a data storing state through the graphic portion, thereby preventing failure of the searching operation.

Also, since the digital video recording apparatus according to embodiments of the present invention is implemented with the text-based and the graphic-based search functions, a user can easily search corresponding recording data based on his/her desired search function.

Although a number of exemplary embodiments of the present invention have been shown and described herein, it can be appreciated by those skilled in the art that changes can be made in these embodiments without departing from the principles and spirit of the invention, the scope of which is defined in the claims and their equivalents.

What is claimed is:

1. A digital video recording apparatus, comprising:
an input unit for inputting time information to be searched through a search screen, based on characters or selection of pictures; and
a searching unit for searching recording data according to the input time information.

2. The apparatus as set forth in claim 1, wherein the search screen is configured to display a text portion and a graphic portion.

3. The apparatus as set forth in claim 2, wherein:
the text portion is configured to input the time information based on characters; and
the graphic portion is configured to display a time when the recording data is recorded based on a picture.

4. The apparatus as set forth in claim 3, wherein the search screen is configured to display the time information of originally recorded recording data of the recording data based on the text portion and the graphic portion when initiating a search of the recording data.

5. The apparatus as set forth in claim 3, wherein the search screen is configured to:
display information of the time when the recording data was originally recorded, including an input date, on the text portion, and an hour displaying area of time for displaying when the recording data was recorded on an input date, on the graphic portion, if the input unit inputs the time information including up to a desired search date and the searching unit completes a searching operation based on the time information.

6. The apparatus as set forth in claim 3, wherein the search screen is configured to:
display information of the time when the recording data was originally recorded, including an input hour, on the text portion, and a minute displaying area of time for displaying when the recording data was recorded on an input hour, on the graphic portion, if the input unit inputs the time information including up to a desired search hour and the searching unit completes a searching operation based on the time information.

7. The apparatus as set forth in claim 6, wherein the graphic portion is configured as a tool bar for performing a specific search for corresponding recording data in the display area of time information.

8. An apparatus for associating a text-based search function with a graphic-based search function and performing a searching operation according to a user's desired search function, comprising:
a controller;
an audio/video (A/V) input/output unit for inputting audio and video signals from a camera and converting the audio and video signals into digital signals to generate frame data;
an A/V encoder for inputting and encoding the frame data from the A/V input/output unit and initiating an encoding operation when receiving an encoding start command from the controller and terminating an encoding operation based on a stop command;
a storing unit for storing the video and audio recording data encoded in the A/V encoder;
an A/V decoder for decoding the video and audio recording data stored in the storing unit when receiving a decoding start command from the controller;
a key input for selecting a search function in order to search corresponding recording data in recording data stored in the storing unit;
an input/output interface unit for inputting corresponding key data from the key input and transmitting the corresponding key data to the controller; and
a display unit for performing analog/digital conversion for the frame data output from the A/V decoder and outputting the converted video and audio signals through a monitor, wherein the display unit displays a search screen comprised of a text portion and a graphic portion when a search function is selected.

9. The apparatus as set forth in claim 8, wherein:
the text portion is configured to input the time information based on characters; and
the graphic portion is configured to display a time when the recording data is recorded based on a picture.

10. A method for associating a text-based search function with a graphic-based search function and performing a searching operation according to a user's desired search function, comprising the steps of:
inputting time information to be searched through a search screen, based on characters or selection of pictures; and
searching recording data according to the input time information.

11. The method as set forth in claim 10, wherein the search screen is configured to display a text portion and a graphic portion.

12. The method as set forth in claim 11, wherein:
the text portion is configured to input the time information based on characters; and
the graphic portion is configured to display a time when the recording data is recorded based on a picture.

13. The method as set forth in claim 12, further comprising the step of:
displaying the time information of originally recorded recording data of the recording data based on the text portion and the graphic portion when initiating a search of the recording data.
